(19) United States
(12) Patent Application Publication
(10) Pub. No.: US 2018/0042213 A1
(43) Pub. Date: Feb. 15, 2018

(54) BIODEGRADABLE INSECT TRAPS

(71) Applicant: BIOPLASMAR LTD, Ha'Ela (IL)

(72) Inventor: Chanoch SAMET, Ha'Ela (IL)

(21) Appl. No.: 15/549,757

(22) PCT Filed: Feb. 8, 2016
(86) PCT No.: PCT/IL2016/050142

§ 371 Date: Aug. 9, 2017

Related U.S. Application Data
(60) Provisional application No. 62/114,100, filed on Feb. 10, 2015.

(51) Int. Cl. A01M 1/14; A01M 1/10

(52) U.S. Cl. CPC A01M 1/14; A01M 1/106; A01M 2200/012

(57) ABSTRACT

The present invention provides an environmental friendly insect trap based on a solid mixture of at least one organic waste component having particles that are equal to or smaller than 2 mm, at least one organic adhesive component and at least one organic plasticizer or emulsifying agent, and an insect adhering surface attached to the solid mixture.

### FIELD OF THE INVENTION

The invention relates to the field of biodegradable insect traps, and to process of making biodegradable insect traps.

### BACKGROUND OF THE INVENTION

Insect traps are vastly used both for monitoring and reducing populations of arthropods. They typically use food, visual lures, chemical attractants and pheromones as bait and are installed so that they do not injure other animals or humans or result in residues in foods or feeds. Visual lures use light, bright colors and shapes to attract pests. Chemical attractants or pheromones may attract only a specific sex. Insect traps are sometimes used in pest management programs instead of pesticides but are more often used to look at seasonal and distributional patterns of pest occurrence. This information may then be used in other pest management approaches.

Flies are occasionally attracted by proteins. Many other insects are attracted by bright colors, carbon dioxide, lactic acid, floral or fruity fragrances, warmth, moisture and pheromones.

Sticky traps are occasionally simple flat panels or enclosed structures, often baited, that ensnare insects with an adhesive substance. Sticky traps are widely used in agricultural monitoring.

A major source of preoccupation in modern society has been the amount of waste produced and its impact in the environment, increasing pollution and using valuable spaces as landfill. Thus, there has been great interest in the manufacture of biodegradable disposable articles, and especially when these are made from recycled or discarded material.

Alternatives to conventional plastic exist. Biodegradable articles made of paper (cellulose fibers), peat and other organic waste are known. These articles are designed to degrade relatively quickly. This allows consumers to simply bury the articles. However, the biodegradable articles must also be substantially resistant to saturation by liquids so that they do not begin to disintegrate prior to being buried in soil.

### SUMMARY OF THE INVENTION

It is an object of the present invention to provide a device comprising: (a) a solid mixture comprising: at least one organic waste component, at least one organic adhesive component and at least one organic plasticizer or emulsifying agent, wherein the organic waste component comprises particles that are equal to or smaller than 2 mm; and (b) an insect catching surface (such as but not limited to an adhesive insect catching surface) attached to the solid mixture. In another embodiment, a device a described herein is a sticky trap. In another embodiment, a device a described herein is an insect trap. In another embodiment, a device a described herein is a degradable insect trap.

In one embodiment, the present invention provides that the device is biodegradable. In one embodiment, the present invention provides that the device further comprises an insect attractant

It is a further object of the present invention to provide a device comprising: (a) a solid mixture comprising: methylcellulose, plant chips soaked in an organic acid, flour, water, glycerol, mucilage, sorbate acid salt, ash and compost, wherein the plant chips comprises particles that are equal to or smaller than 2 mm; and (b) an insect catching surface attached to the solid mixture.

In another embodiment, further provided herein is a process for making the an insect trap-device, comprising making the solid mixture and attaching the insect catching surface to the solid mixture, wherein making the solid mixture comprises the steps of: a. obtaining a methylcellulose solution; b. mixing the methylcellulose solution, said organic plasticizer, flour, said organic waste component and water; and c. drying the mixture obtained in step b, thereby making the insect trap-device.

### BRIEF DESCRIPTION OF THE FIGURES

The invention will now be described in relation to certain examples and embodiments with reference to the following illustrative figures so that it may be more fully understood. In the drawings:

FIG. 1 is a trap of the invention in the form of a board made of a composition of the invention and a yellow sticky paper (insect attractant and immobilizer) attached thereto. The trap has width of 15 cm, a length 25 cm and a thickness of 0.2 cm. The trap is fixed to a desired location by strap threaded into the upper portion (about 1.5 cm from the top) of the trap.

FIG. 2 illustrates placement of a series of traps of FIG. 1 in a green house.

FIG. 3 is a trap of the invention in the form of a board made of a composition of the invention and a yellow sticky paper (insect attractant and immobilizer) attached to the face of the board. The trap has width of 30 cm, a length 60 cm and a thickness of 0.2 cm. The trap is fixed to the ground via a peg connected to the back portion of the board. The peg extends beyond the length of the board.

FIG. 4 is a trap of the invention in the form of a board made of a composition of the invention and a yellow sticky paper (insect attractant and immobilizer) attached to the face of the board. The trap has width of 20 cm, a length 40 cm and a thickness of 0.2 cm. The trap is placed on a ground surface and is stabilized by a wooden frame (leg) connected to the back portion of the board.

FIG. 5 is a photograph showing the trapping capacity of the current invention/experimental trap (B) based on a board as described herein (see examples 1-3) versus a commercial trap (A) based on plastic board (both trap contain the same yellow sticky surface). The experimental trap was found to be more than 2.5 times more effective in attracting and adhering insects than the commercial trap.

### DETAILED DESCRIPTION OF THE INVENTION

The present inventors have attained a biodegradable, environmental friendly insect traps that utilize a receptacle made of a natural non-toxic, environmental friendly mixture that can readily disintegrate. In one embodiment, the present invention provides a device comprising: (a) a mixture comprising: at least one organic waste component, at least one organic adhesive component and at least one organic plasticizer or emulsifying agent, and (b) an insect catching surface attached to said solid mixture. In another embodiment, the mixture is an aqueous solution disintegrable solid mixture. In another embodiment, the mixture is a solid mixture. In another embodiment, the mixture is a hard mixture. In another embodiment, the mixture is in the form of a hard dry board. In another embodiment, the mixture is a dry mixture. In another embodiment, the mixture comprises less than 5% by weight water or any other aqueous solution.

In another embodiment, the term “about” is ±5% of the recited value. In another embodiment, the term “about” is ±10% of the recited value or number. In another embodiment, the term “about” is ±15% of the recited value. In another embodiment, the term “about” is ±20% of the recited value. In another embodiment, the term “about” is ±25% of the recited value.

In another embodiment, a dry mixture as described herein can disintegrate by contacting it with an aqueous solution such as but not limited to water. In another embodiment, disintegration is initiated once the dry mixture contains or absorbs an aqueous solution. In another embodiment, disintegration is initiated once the dry mixture contains or absorbs an aqueous solution. In another embodiment, disintegration is initiated once the dry mixture contains or absorbs at least 7% w/w aqueous solution or water. In another embodiment, disintegration is initiated once the dry mixture contains or absorbs at least 10% w/w aqueous solution or water. In another embodiment, disintegration is initiated once the dry mixture contains or absorbs at least 15% w/w aqueous solution or water. In another embodiment, disintegration is initiated once the dry mixture contains or absorbs at least 25% w/w aqueous solution or water. In another embodiment, disintegration is initiated once the dry mixture contains or absorbs at least 30% w/w aqueous solution or water. In another embodiment, disintegration is initiated once the dry mixture contains or absorbs at least 40% w/w aqueous solution or water. In another embodiment, disintegration is initiated once the dry mixture contains or absorbs at least 50% w/w aqueous solution or water.

In another embodiment, a mixture comprising: at least one organic waste component, at least one organic adhesive component and at least one organic plasticizer or emulsifying agent serves as a platform or a carrier for a composition capable of attracting and/or trapping and/or immobilizing an insect. In another embodiment, a mixture such as described herein unexpectedly attracts more insects and/or flies compared to a trap composed of a plastic carrier (such as a board). In another embodiment, a mixture such as described herein unexpectedly attracts at least twice the number of insects and/or flies per 9 cm² of attracting area and/or trapping area and/or immobilizing area compared to a trap composed of a plastic carrier (such as a board). In another embodiment, a mixture such as described herein unexpectedly attracts at least 2.2 the number of insects and/or flies per 9 cm² of attracting area and/or trapping area and/or immobilizing area compared to a trap composed of a plastic carrier (such as a board). In another embodiment, a mixture such as described herein unexpectedly attracts about 3 times the number of insects and/or flies per 9 cm² of attracting area and/or trapping area and/or immobilizing area compared to a trap composed of a plastic carrier (such as a board). A trap composed of a plastic carrier is a trap parallel to a trap of the invention wherein the only difference between the trap composed of a plastic carrier and the present trap is the carrier, board or platform as described herein (example 7).

In another embodiment, an experimental trap is a trap of the invention comprising a dry mixture as described herein. In another embodiment, an experimental trap is a trap wherein a dry mixture as directly connected and/or attached and/or glued and/or affixed to a catching surface. In another embodiment, an experimental trap is composed of a dried solid support (such as described in the examples section) attached or connected to an insect or an arthropods attractant. In another embodiment, an experimental trap is composed of a dried solid support (such as described in the examples section) attached or connected to a composition capable of adhering, trapping, immobilizing and/or eliminating an insect, a flying insect or a fly. In another embodiment, a composition capable of adhering, trapping, or immobilizing an insect, a flying insect or a fly, eliminates an insect, a flying insect or a fly. In another embodiment, a composition capable of attracting, an insect, a flying insect or a fly eliminates an insect, a flying insect or a fly. In another embodiment, an experimental trap is composed of a dried solid support (such as described in the examples section) in the form of a board and a yellow, blue, green or red sticky paper (adhered onto the solid support) that is known to attract and immobilize/trap insects and/or flies.

In another embodiment, a trap as described herein or a mixture comprising: at least one organic waste component, at least one organic adhesive component and at least one organic plasticizer or emulsifying agent further fertilizes the soil or the ground upon disintegration or contact with the soil or the ground. In another embodiment, a trap comprising insects or arthropods as described herein or a mixture comprising: insects/arthropods, at least one organic waste component, at least one organic adhesive component and at least one organic plasticizer or emulsifying agent further fertilizes the soil or the ground upon disintegration or contact with the soil or the ground.

In another embodiment, an experimental trap or a dry mixture as described herein is devoid of a coating. In another embodiment, an experimental trap or a dry mixture as described herein is devoid of shellac or lac. In another embodiment, an experimental trap or a dry mixture as described is colloidal. In another embodiment, an experimental trap or a dry mixture as described is hydroscopic. In another embodiment, an experimental trap or a dry mixture as described is deliquescence.

In one embodiment, a device such as described herein is an insect trap. In one embodiment, a device such as described herein is used to monitor populations of insects and/or other arthropods. In one embodiment, a device such as described herein is used to reduce populations of insects or other arthropods. In another embodiment, a device such as described herein is used in pest management programs. In one embodiment, an insect trap as described herein further comprises means for hanging the insect trap, such as but not limited to a sticky hanging surface, a niche for a nail or a screw, a strip, or a thread. In one embodiment, an insect trap as described herein is attached to a solid surface such as a tree or a log. In one embodiment, an insect trap as described herein includes means for anchoring it to the ground. In one embodiment, an insect trap as described herein includes means for stabilizing it on a ground surface. In one embodiment, an insect trap as described herein includes means for anchoring it to the ground. In one embodiment, an insect trap as described herein includes means for anchoring it to the ground.

In one embodiment, a device such as described herein further comprises an insect attractant. In another embodiment, an insect attractant is food. In another embodiment, an insect attractant is processed or unprocessed feces. In another embodiment, an insect attractant is compost. In another embodiment, an insect attractant is organic waste. In another embodiment, an insect attractant is a visual lure or an insect visual lure. In another embodiment, an insect attractant is a, chemical attractant. In another embodiment, an insect attractant is a pheromone. In another embodiment, an insect attractant is an ingredient of a mixture such as described herein. In another embodiment, an insect attractant is applied to the device of the invention. In another embodiment, an insect attractant is in contact with a device or a mixture as described herein. In another embodiment, an insect attractant is sprayed onto a device or a mixture as described herein. In another embodiment, an insect attractant is a protein. In another embodiment, an insect attractant is a colored article. In another embodiment, a color as an attractant is sprayed or painted on the device or any part thereof. In another embodiment, a colored or color are of a bright color. In another embodiment, an insect attractant is carbon dioxide. In another embodiment, an insect attractant is a lactic acid. In another embodiment, an insect attractant is a fragrance. In another embodiment, an insect attractant is a floral fragrance or a fruity fragrance. In another embodiment, an insect attractant is a heated article. In another embodiment, an insect attractant is moisture. In another embodiment, an insect attractant is a synthetic attractant. In another embodiment, an insect attractant is methyl eugenol.

In one embodiment, the present invention presents an insect trap, used in agriculture, produced from organic waste (such as wood-waste and soil) and adhesives, optionally coated with biopolymers. Thus, this product is completely biodegradable and recyclable. In one embodiment, a biodegradable insect trap further comprises trapped insects. In one embodiment, a biodegradable insect trap is degraded in-situ. In one embodiment, the degrading biodegradable insect trap enriches the soil at a site of disposing it with nutrients, fertilizers, anti-mold agent, anti-fungal agent, and/or anti-yeast agent.

In some embodiments, discarding an insect trap after use in soil results in enrichment of the soil with nutrients and plant growth stimulators. One major advantage of the insect trap of the invention is its ability to decompose and integrate within the soil's organic matter, after its role as an insect trap ends.

In one embodiment, a mixture as described herein serves as a receptacle or as a framework to an insect trap which further comprises means to attract insects (insects attractant) and means for eliminating insects (such as but not limited to an insect catching surface). In another embodiment, Thus, in a first aspect the present invention provides a mixture comprising:
(a) at least one organic waste component;
(b) at least one organic adhesive component;
(c) optionally, at least one organic plasticizer, mucilage, anti-fungal agent, anti-mold agent, anti-yeast agent, sorbate acid salt, emulsifying agent or any combination thereof; and
(d) optionally, water.

In some embodiments, a mixture of the invention is in the form of a board or a plate. In some embodiments, a mixture of the invention is in the form of a bowl or a dish. In some embodiments, a mixture of the invention is in the form of a sphere. In another embodiment, a device such as described herein further comprises a mounting means that is attached to or otherwise associated with a back surface of the device. In some embodiments, a mixture of the invention is in the form of a tray.

In some embodiments, a mixture of the invention is 0.01 cm to 1 cm thick. In some embodiments, a mixture of the invention is 0.01 cm to 0.5 cm thick. In some embodiments, a mixture of the invention is 0.01 cm to 1 cm thick. In some embodiments, a mixture of the invention is 0.1 cm to 0.5 cm thick. In some embodiments, a mixture of the invention is 0.2 cm to 0.8 cm thick.

In another embodiment, a mixture of the invention further comprises compost. In another embodiment, a mixture of the invention further comprises organic waste.

In some embodiments, the device of the invention includes an insect attractant such as but not limited to light. In another embodiment, light is electrically energized light source for attracting insects. In another embodiment, light and electrically energized light for attracting insects are known to those of skill in the art. In some embodiments, the insect attractant is UV radiation. In some embodiments, the insect attractant is visible flourescent lamp source. In another embodiment, the insect attractant is a green light. In another embodiment, the insect attractant is a white light. In another embodiment, the insect attractant is a yellow light. In another embodiment, an insect catching surface is situated beneath the light source. In another embodiment, the light source reflects light towards the insect catching surface is situated beneath. In another embodiment, a catching surface further attracts insects. In another embodiment, a catching surface immobilizes insects. In another embodiment, a catching surface adheres and/or glues insects. In another embodiment, catching surface eliminates insects.

In some embodiments, the insect attractant is a semiochemical. In some embodiments, the insect attractant is a pheromone. In another embodiment, the insect attractant is an allelochemical. In another embodiment, the insect attractant is a volatile compound. In some embodiments, the insect attractant is a kairomone. In another embodiment, the insect attractant is a synthetic attractant such as a mimetic of sex or aggregation pheromone. In another embodiment, the insect attractant is a synthetic feeding attractant.

In another embodiment, a device as described herein, the insect trap, is used as a lure to monitor pest populations. In another embodiment, a device as described herein, the insect trap, is used to “trap out” a pest population. In another embodiment, the insect trap is used as a signal for disrupting insect mating. In another embodiment, the insect trap is used as bait comprising an insecticide.

In another embodiment, the insect catching surface is glue situated on a surface exposed to insects. In another embodiment, the glue is disposable. In another embodiment, the insect catching surface is a sticky paper. In another embodiment, the insect catching surface is an insect immobilizer. In another embodiment, the insect catching surface is a glue-board. In another embodiment, the insect catching surface is a glue sheet. In another embodiment, the insect catching surface is a sticky roll. In another embodiment, the insect catching surface is a duct tape. In another embodiment, the insect catching surface comprises a dry-sticky surface, wet-sticky surface, or both. In another embodiment, a device of the invention comprises a dry-sticky surface, wet-sticky surface, or both. In another embodiment, the insect catching surface comprises polyisobutylene (PIB). In another embodiment, the insect catching surface comprises polybutene oil. In another embodiment, the insect catching surface is yellow, sticky-coated card or a portion thereof. In another embodiment, the insect catching surface is green, sticky-coated card or a portion thereof.

In another embodiment, a device as described herein comprises at least one insect catching surface. In another embodiment, at least one surface of the present device or the mixture at least one insect catching surface. In another embodiment, the “insect catching surface” is substituted with an insect terminator or elimination such a sticky surface, an electric source or a heat source.

In another embodiment, the insect catching surface is scented (insect attractant) for attracting insects to it. In another embodiment, the insect catching surface comprises an insect attractant.

In one embodiment of the invention, the weight (w:w) ratio between the organic waste and organic adhesive (components a:b of the mixture) ranges from about 1:1 to 3:1. In one embodiment of the invention, the weight (w:w) ratio between the organic waste and organic adhesive (components a:b of the mixture) is about 2:1. In one embodiment of the invention, the weight (w:w) ratio between the organic waste and organic adhesive (components a:b of the mixture) is about 1:1.

In one embodiment of the invention, the weight ratio within mixture of water compared to the organic waste is at least 1.5. In one embodiment of the invention, the weight ratio within mixture of water compared to the organic waste is at least 1.8. In one embodiment of the invention, the weight ratio within mixture of water compared to the organic waste is at least 2.0. In one embodiment of the invention, the weight ratio within mixture of water compared to the organic waste is at least 2.2.

In one embodiment of the invention, the weight ratio within mixture of water compared to the organic adhesive is at least 1.5 and small than 10. In one embodiment of the invention, the weight ratio within mixture of water compared to the organic adhesive is at least 1.8 and smaller than 8. In one embodiment of the invention, the weight ratio within mixture of water compared to the organic adhesive is at least 2.0 and smaller than 5. In one embodiment of the invention, the weight ratio within mixture of water compared to the organic adhesive is at least 2.0 and smaller than 4.

In one embodiment of the invention, the weight ratio within mixture of organic waste compared to the organic adhesive is at least 1.5 and smaller than 8. In one embodiment of the invention, the weight ratio within mixture of organic waste compared to the organic adhesive is at least 1.8 and smaller than 5. In one embodiment of the invention, the weight ratio within mixture of organic waste compared to the organic adhesive is at least 2 and smaller than 4.

In one embodiment of the invention, the organic waste component comprises cellulose and minerals. According to some embodiments the organic waste component is any one of wood chips, sawdust, soil, dirt, lop, grass clippings, leaves, hay, straw, shredded bark, whole bark nuggets, sawdust, shells, woodchips, shredded newspaper, cardboard, wool, peat, calcium carbonate (typically used in industry to entrap impurities, such as in the sugar production industry), coffee residues, wood ash or other organic material ash, or any combination thereof. In one embodiment, soil is compost. In one embodiment, a composition as described herein comprises is cellulose glycol.

In one embodiment of the invention, the organic waste component comprises particles that are equal to or smaller than 4 mm. In one embodiment of the invention, the organic waste component comprises particles that are equal to or smaller than 3 mm. In one embodiment of the invention, the organic waste component comprises particles that are equal to or smaller than 2.8 mm. In one embodiment of the invention, the organic waste component comprises particles that are equal to or smaller than 2.5 mm. In one embodiment of the invention, the organic waste component comprises particles that are equal to or smaller than 2.2 mm. In one embodiment of the invention, the organic waste component comprises particles that are equal to or smaller than 2 mm. In one embodiment of the invention, more than 80% of the organic waste component particles are equal to or smaller than 2 mm (in any direction). In one embodiment of the invention, more than 85% of the organic waste component particles are equal to or smaller than 2 mm (in any direction). In one embodiment of the invention, more than 90% of the organic waste component particles are equal to or smaller than 2 mm (in any direction). In one embodiment of the invention, more than 95% of the organic waste component particles are equal to or smaller than 2 mm (in any direction).

In one embodiment of the invention, smaller than 2 mm is smaller than 1.5 mm. In one embodiment of the invention, smaller than 2 mm is smaller than 1.2 mm. In one embodiment of the invention, smaller than 2 mm is smaller than 1.0 mm. In one embodiment of the invention, smaller than 4 mm or 2 mm bigger than 0.0001 mm. In one embodiment of the invention, smaller than 4 mm or 2 mm bigger than 0.001 mm. In one embodiment of the invention, smaller than 4 mm or 2 mm bigger than 0.01 mm. In one embodiment of the invention, smaller than 4 mm or 2 mm bigger than 0.1 mm.

In one embodiment, the organic waste component is a mixture of any two or more components selected from: soil, ash, compost, woodchips, and saw dust. In another embodiment, compost is any compost known to one of average skill in the art. In another embodiment, compost is the result of Grub composting. In another embodiment, compost is Bokashi compost. In another embodiment, a compost comprises EM1 (lactica acid bacteria, yeast and phototrophic (PNSB) bacteria). In another embodiment, compost is compost tea. In another embodiment, compost is Hügelkultur. In another embodiment, compost comprises Humanure. In another embodiment, compost is Vermicompost.

According to some embodiments of the invention the organic waste component includes material having different sized particles. The particles may be between 0.125 mm-2 mm in size. According to one embodiment particles of a size larger than 2 mm are used.

Best results may be obtained when the soil is rich in clay. Clay is the most active mineral component of soil. It is a colloidal and crystalline material. In soils, clay is defined in a physical sense as any mineral particle less than two microns in effective diameter. Clay is now known to be a precipitate with a mineralogical composition different from its parent materials and is classed as a secondary mineral. The type of clay that is formed is a function of the parent material and the composition of the minerals in solution. The clays of soil are a mixture of the various types of clay (crystalline, amorphous or sesquioxide) but one type predominates. One example of an ideal soil to be employed in the mixture of the invention is the soil found in Northwestern Europe, e.g. in Germany.

In another embodiment of the invention, the organic adhesive component is any one of a starch containing material (such as flour), methylcellulose, carboxymethylcellulose, or a combination thereof. In one specific embodiment, two organic adhesive components are included in the mixture of the invention, e.g., flour and methylcellulose.

In another embodiment, the weight (w:w) ratio between the organic adhesive component and the organic waste ranges from 1:1 to 1:3. In another embodiment, the weight (w:w) ratio between the organic adhesive component and the organic waste ranges from 1:1 to 1:2. In another embodiment, the weight (w:w) ratio between the organic adhesive component and the organic waste ranges from 1:1 to 1:3. In another embodiment, the weight (w:w) ratio between the organic adhesive component and the organic waste ranges from 1:1.5±20%. In another embodiment, the weight (w:w) ratio between the organic adhesive component and the organic waste component is 1:1.5±10%.

Flour is known for its adhesive properties. It is to be understood that the term “flour” may include any one of wheat flour, flour from grains, such as those chosen from buckwheat flour, semolina flour, corn flour, corn starch, corn sledge, rice flour, tapioca flour, articleato flour, soy flour, ground flax meal, flax flour, hemp flour, and any mixtures thereof.

According to one embodiment two adhesives are added to the mixture. According to one embodiment one of the adhesives is methylcellulose, typically in a 1.25% solution. For stronger adhesiveness a more concentrated (e.g., a 1.5% aqueous solution) methylcellulose stock may be used.

According to some embodiments a plasticizer or emulsifying agent is added to the mixture to provide plasticity to the mixture to avoid cracking of receptacles made with this mixture.

Thus, in another embodiment of the invention, the mixture further comprises any one of glycerol, glycerin, polyethylene glycol (PEG), or any other suitable emulsifier. In one specific embodiment, the mixture comprises glycerol.

Glycerol (or any of its appropriate equivalents) provides a certain degree of flexibility, stretch ability or elasticity to the mixture, which translates into shock-resistance properties to the articles or containers manufactured with the mixture of the invention. This property may be particularly relevant during the manufacturing process, but also when the articles or containers are transported to and from retailers.

In some embodiments, the mixture further comprises mold, fungus, and/or yeast inhibitor. In one embodiment, the inhibitor is articleassium sorbate. In one embodiment, the inhibitor is calcium sorbate. In one embodiment, the inhibitor is Sorbic Acid. In one embodiment, the inhibitor is Natamycin. In one embodiment, the inhibitor is calcium Acetate. In one embodiment, the inhibitor is calcium Propionate. In one embodiment, the inhibitor is articleassium Propionate. In one embodiment, the inhibitor is Sodium Diacetate.

In another embodiment, the weight (w:w) ratio between the organic adhesive component and the mold, fungus, and/or yeast inhibitor ranges from 10:1 to 30:1. In another embodiment, the weight (w:w) ratio between the organic adhesive component and the mold, fungus, and/or yeast inhibitor 20:1±30%. In another embodiment, the weight (w:w) ratio between the organic adhesive component and the mold, fungus, and/or yeast inhibitor is 20:1±20%. In another embodiment, the weight (w:w) ratio between the organic adhesive component and the mold, fungus, and/or yeast inhibitor is 20:1±15%.

In some embodiments, the mixture further comprises mucilage. In one embodiment, mucilage is a thick mixture of polar glycoprotein and an exopolysaccharide produced by a plant or a microorganism.

In some embodiments, mucilage is derived from Aloe vera. In another embodiment, mucilage is derived from Basella alba (Malabar spinach). In another embodiment, mucilage is derived from cactus. In another embodiment, mucilage is derived from Chondrus crispus (Irish moss). In another embodiment, mucilage is derived from Dioscorea opposita (nagaimo, Chinese yam). In another embodiment, mucilage is derived from Drosera (sundews). In another embodiment, mucilage is derived from Drosophyllum lusitanicum. In another embodiment, mucilage is derived from fenugreek. In another embodiment, mucilage is derived from flax seeds. In another embodiment, mucilage is derived from kelp. In another embodiment, mucilage is derived from liquorice root. In another embodiment, mucilage is derived from marshmallow. In another embodiment, mucilage is derived from mallow. In another embodiment, mucilage is derived from mullein. In another embodiment, mucilage is derived from okra. In another embodiment, mucilage is derived from parthenium. In another embodiment, mucilage is derived from pinguicula (butterwort). In another embodiment, mucilage is derived from Psyllium seed husks. In another embodiment, mucilage is derived from salvia hispanica (chia) seed. In another embodiment, mucilage is derived from Ulmus rubra bark (slippery elm).

In one embodiment, mucilage is Trigonella foenum-graecum mucilage. In another embodiment, the weight (w:w) ratio between the organic adhesive component and mucilage ranges from 10:1 to 30:1. In another embodiment, the weight (w:w) ratio between the organic adhesive component and mucilage is 20:1±30%. In another embodiment, the weight (w:w) ratio between the organic adhesive component and mucilage is 20:1±20%. In another embodiment, the weight (w:w) ratio between the organic adhesive component and mucilage is 20:1±15%.

In another embodiment, a mixture as described herein comprises both sawdust and compost. In another embodiment, the weight (w:w) ratio between sawdust and compost is 4:1 to 1:2. In another embodiment, the weight (w:w) ratio between sawdust and compost is 3:1 to 1:1. In another embodiment, the weight (w:w) ratio between sawdust and compost is 2:1 to 1:1. In another embodiment, the weight (w:w) ratio between sawdust and compost is 2:1±30%. In another embodiment, the weight (w:w) ratio between sawdust and compost is 2:1±20%. In another embodiment, the weight (w:w) ratio between sawdust and compost is 2:1±10%. In another embodiment, the weight (w:w) ratio between sawdust and compost is 1:1±30%. In another embodiment, the weight (w:w) ratio between sawdust and compost is 1:1±20%. In another embodiment, the weight (w:w) ratio between sawdust and compost is 1:1±10%.

In another embodiment, a mixture as described herein comprises both soil and compost. In another embodiment, the weight (w:w) ratio between soil and compost ranges from 4:1 to 1:2. In another embodiment, the weight (w:w) ratio between soil and compost is 3:1 to 1:1. In another embodiment, the weight (w:w) ratio between soil and compost ranges from 2:1 to 1:1. In another embodiment, the weight (w:w) ratio between soil and compost is 2:1±30%. In another embodiment, the weight (w:w) ratio between soil and compost is 2:1±20%. In another embodiment, the weight (w:w) ratio between soil and compost is 2:1±10%. In another embodiment, the weight (w:w) ratio between soil and compost is 1:1±30%. In another embodiment, the weight (w:w) ratio between soil and compost is 1:1±20%. In another embodiment, the weight (w:w) ratio between soil and compost is 1:1±10%. In another embodiment, the weight (w:w) ratio between soil and compost is 1:2±30%. In another embodiment, the weight (w:w) ratio between soil and compost is 1:2±20%. In another embodiment, the weight (w:w) ratio between soil and compost is 1:2±10%.

In some embodiments, the mixture further comprises Propylene glycol. In some embodiments, Propylene glycol is used according to the invention as a humectant. In some embodiments, Propylene glycol is used to prevent cracks in the solid mixture.

In one embodiment, a device of the invention further comprises insects bound, attached, immobilized and/or adhered to the device and/or to the insect catching surface. In one embodiment, an insect catching surface is an adhesive insect catching surface. In one embodiment, an adhesive insect catching surface has an adhesive surface for catching and immobilizing insects. In one embodiment, an adhesive insect catching surface has an adhesive surface for sticking or attaching it onto a solid and/or dry composition as described herein.

In some embodiment, the mixture comprises water. In some embodiments, the volume (v:v) ratio between water and the emulsifier ranges from 4:1 to 45:1. In some embodiments, the volume (v:v) ratio between water and the emulsifier ranges from 8:1 to 40:1. In some embodiments, the volume (v:v) ratio between water and the emulsifier ranges from 10:1 to 35:1. In some embodiments, the volume (v:v) ratio between water and the emulsifier ranges from 15:1 to 30:1. In some embodiments, the volume (v:v) ratio between water and the emulsifier is 23:1±20%. In some embodiments, the volume (v:v) ratio between water and the emulsifier is 23:1±10%. In one embodiment, the emulsifier is glycerol.

In some embodiments, the volume (v:v) ratio between the emulsifier and the organic adhesive component (the organic adhesive component is in a solution containing the adhesive component in a concentration of 12.5 gr per 1 liter of water) ranges from 10:1 to 1:10. In some embodiments, the volume (v:v) ratio between the emulsifier and the organic adhesive ranges from 5:1 to 1:5. In some embodiments, the volume (v:v) ratio between the emulsifier and the organic adhesive ranges from 1:3 to 3:1. In some embodiments, the volume (v:v) ratio between the emulsifier and the organic adhesive ranges from 2:1 to 1:2. In some embodiments, the volume (v:v) ratio between the emulsifier and the organic adhesive component is 1:1±20%. In some embodiments, the volume (v:v) ratio between the emulsifier and the organic adhesive component is 1:1±10%. In one embodiment, the organic adhesive component is methylcellulose. In one embodiment, the emulsifier is glycerol.

In some embodiments, the volume (v:v) ratio between water and the organic adhesive component (the organic adhesive component is in a solution containing the adhesive component in a concentration of 12.5 gr per 1 liter of water) ranges from 4:1 to 45:1. In some embodiments, the volume (v:v) ratio between water and the organic adhesive ranges from 8:1 to 40:1. In some embodiments, the volume (v:v) ratio between water and the organic adhesive ranges from 10:1 to 35:1. In some embodiments, the volume (v:v) ratio between water and the organic adhesive ranges from 10:1 to 20:1. In some embodiments, the volume (v:v) ratio between water and the organic adhesive component is 23:1±20%. In some embodiments, the volume (v:v) ratio between water and the organic adhesive component is 23:1±10%. In one embodiment, the organic adhesive component is methylcellulose.

In some embodiments, the volume (v:v) ratio between the emulsifier and propylene glycol ranges from 5:1 to 1:1. In some embodiments, the volume (v:v) ratio between the emulsifier and propylene glycol ranges from 4:1 to 1:1. In some embodiments, the volume (v:v) ratio between the emulsifier and propylene glycol ranges from 3:1 to 1:1. In some embodiments, the volume (v:v) ratio between the emulsifier and propylene glycol ranges from 1.8:1 to 1.2:1. In some embodiments, the volume (v:v) ratio between the emulsifier and propylene glycol is 1.6:1±20%. In some embodiments, the volume (v:v) ratio between the emulsifier and the organic adhesive component is 1.6:1±10%. In one embodiment, the emulsifier is glycerol.

In some embodiments, a device as described herein consists or comprises the mixture and a coating layer. In some embodiments, a device as described herein consists or comprises the mixture, a coating layer, and insects attached to the device. In some embodiments, a device as described herein consists or comprises the mixture, optionally a coating layer, and insects.

In some embodiments, an uncoated mixture average weight is: 75.0±8.0 g. In some embodiments, an uncoated mixture's average weight is: 75.0±6.0 g. In some embodiments, an uncoated mixture's average weight is: 75.0±4.0 g. In some embodiments, an uncoated mixture's average weight is: 75.0±3.0 g. In another embodiment, the phrase “uncoated article” is uncoated standard 12 cm article. In another embodiment, one of skill in the art can readily adapt the physical properties and measures to bigger or smaller articles.

In some embodiments, an uncoated mixture's average material density is: 0.79±0.5 g/mL. In some embodiments, an uncoated mixture's average material density is: 0.79±0.4 g/mL. In some embodiments, an uncoated mixture's average material density is: 0.79±0.3 g/mL. In some embodiments, an uncoated mixture's average material density is: 0.79±0.4 g/mL.

In some embodiments, the vertical strength of the uncoated mixture was measured by the application of 70 kg of weight applied vertically, and is equivalent to 2-8 kg/cm2, 4-6 kg/cm2, or 5 kg/cm2, Vertical strength of coated mixture=80 kg pressure applied on the dry mixture (described below) is 3-10 kg/cm2, 4-8 kg/cm2, or 5-7 kg/cm2. In some embodiments, the lateral strength of uncoated dry mixture is 1-6 kg. In some embodiments, the lateral strength of uncoated dry mixture is 2-5 kg. In some embodiments, the lateral strength of coated dry mixture is 4-10 kg. In some embodiments, the lateral strength of coated dry mixture is 5-8 kg. In some embodiments, the lateral strength of coated dry mixture is 5-7 kg.

In another embodiment, the punch test strength (experimental details below) of an uncoated dry mixture is 6.4 kg/cm2±30% near the top of the dry mixture, 10.6 kg/cm2±30% near bottom of the dry mixture, for an average of 8.5 kg/cm2±30%. In another embodiment, the punch test strength of an uncoated dry mixture is 6.4 kg/cm2±15% near the top of the dry mixture, 10.6 kg/cm2±15% near the bottom of the dry mixture for an average of 8.5 kg/cm2±15%. In another embodiment, the punch test strength of an uncoated dry mixture is 6.4 kg/cm2±10% near the top of the dry mixture, 10.6 kg/cm2±10% near the bottom of the dry mixture, for an average of 8.5 kg/cm2±10%. In another embodiment, the punch test strength of an uncoated dry mixture is 6.4 kg/cm2±5% near the top of the dry mixture, 10.6 kg/cm2±5%. near the bottom of the dry mixture, for an average of 8.5 kg/cm2±5%.

35 In another embodiment, the unch test strength (experimental details below) of the coated dry mixture is 8.5 kg/cm2±30% near the top of the dry mixture, 13.8 kg/cm2±30% near the bottom of the dry mixture, for an average of 11.2 kg/cm2±30%. In another embodiment, the punch test strength of a coated dry mixture is 8.5 kg/cm2±15% near the top of the dry mixture, 13.8 kg/cm2±15% near the bottom of the dry mixture, for an average of 11.2 kg/cm2±15%. In another embodiment, the punch test strength of a coated dry mixture is 8.5 kg/cm2±10% near the top of the dry mixture, 13.8 kg/cm2±10% near the bottom of the dry mixture, for an average of 11.2 kg/cm2±10%. In another embodiment, the punch test strength of a coated dry mixture is 8.5 kg/cm2±5% near the top of the dry mixture, 13.8 kg/cm2±5% near the bottom of the dry mixture, for an/average of 11.2 kg/cm2±5%.

36 In another embodiment, a dry mixture as described herein is prepared according to the following steps: optional pre-preparation of wood chips or sawdust by soaking in an organic acid solution. A fraction (10-30%) of the starch from the overall recipe is added and steam is applied to approximately 15% humidity.

In another embodiment, the Punch test strength of uncoated dry mixture is: top of dry mixture/near bottom of dry mixture/average is 6.4/10.6/8.5 kg/cm²±30%. In another embodiment, the Punch test strength of uncoated dry mixture is: top of dry mixture/near bottom of dry mixture/average is 6.4/10.6/8.5 kg/cm²±15%. In another embodiment, the Punch test strength of uncoated dry mixture is: top of dry mixture/near bottom of dry mixture/average is 6.4/10.6/8.5 kg/cm²±10%. In another embodiment, the Punch test strength of uncoated dry mixture is: top of dry mixture/near bottom of dry mixture/average is 6.4/10.6/8.5 kg/cm²±5%.

In another embodiment, the Punch test strength of coated dry mixture: top of dry mixture/near bottom of dry mixture/average is 8.5/13.8/11.2 kg/cm²±30%. In another embodiment, the Punch test strength of coated dry mixture: top of dry mixture/near bottom of dry mixture/average is 8.5/13.8/11.2 kg/cm²±15%. In another embodiment, the Punch test strength of coated dry mixture: top of dry mixture/near bottom of dry mixture/average is 8.5/13.8/11.2 kg/cm²±10%. In another embodiment, the Punch test strength of coated dry mixture: top of dry mixture/near bottom of dry mixture/average is 8.5/13.8/11.2 kg/cm²±5%.

In another embodiment, a dry mixture as described herein is prepared according to the following steps: optionally pre-preparation of wood chips or sawdust by soaking it in an organic acid solution. Then about 25% the flour (starch) is added and steam is applied to approximately 15% humidity.

In another embodiment, the invention further provides a process for making a mixture, comprising the steps of: a. obtaining a methylcellulose solution; and b. mixing methylcellulose solution, an organic plasticizer, flour, an organic waste component and water. In another embodiment, step b. further includes adding and mixing mucilage, a sorbic acid salt, or a combination thereof. In another embodiment, an organic waste component comprises compost, soil, ash, wood chips or their combination.

In another embodiment, the process of preparing the mixture is performed under constant mixing. In some embodiments, lukewarm water (20-30°), methylcellulose, propylene glycol, and glycerol are mixed. In another embodiment, mixing is mixing until the mixture is homogenous.

In another embodiment, articleassium sorbate and/or calcium sorbate are added to the mixture. In another embodiment, organic acid treated wood chips and/or sawdust are added to the lukewarm water, methylcellulose, propylene glycol, and glycerol mixture. In another embodiment, mucilage is further added to the mixture. In another embodiment, each step of adding a material to the mixture is accompanied by mixing.

In another embodiment, ash or any source of cellulosic/lignocellulosic material is further added and mixed. In another embodiment, the 75% remaining flour is added and mixed. In another embodiment, compost is added and mixed. In another embodiment, soil/dirt mixture is added and mixed. In another embodiment, slow-release fertilizer (e.g. Osmocoat, articleassium humate granular, etc.) is optionally added and mixed.

In another embodiment, dough was stored in a proofer to maintain moisture levels and to increase material temperature to 30-50° C. In another embodiment, a board of dry mixture is made by press.

In some embodiments, the dry mixture of any form and or shape is pre-heated to 120-180° C. In some embodiments, the dry mixture of any form and or shape is further oiled with an emulsion of water and palm oil in a 40:60 ratio, a 50:50 ratio, a 60:40 ratio or any ratio ranging from 70:30 to 30:70. In another embodiment, the dough was separated via automated procedure into small flattened-spherical masses, whose weight were depend on the product being formed (e.g. for 12 cm sphere-130-150 gr each).

In another embodiment, the masses of the mixture to be used were situated onto the base of mold; and the plunger or the sheath-plunger is raised slowly down all the way onto the base (30-180 s). In another embodiment, the temperature of the mold pieces was increased to: base, 180-220° C.; sheath, 180-220° C.; plunger, 160-200° C., or sheath-plunger, 160-200° C., then the mixture is baked for 3-9 minutes.

In another embodiment, the mixture is injected and molded into its final shape. In another embodiment, the mold is either opened at once, or pre-cooled and then opened; the dry mixture of any form and or shape is then removed from the base, and allowed to further cool to room temperature. In another embodiment, the dry mixture of any form and or shape is further coated as described in co-pending PCT application PCT/IL2011/000739.

In one embodiment of the invention, and as exemplified in the Examples herein below, in order to produce, for example, a sphere of 12 cm diameter, the mixture of the invention comprises:
(a) 55-65 g (i.e. 55, 56, 57, 58, 59, 60, 61, 62, 63, 64 or 65 g, including any fractions thereof) of saw dust combined with soil;
(b) 25-35 g (i.e. 25, 26, 27, 28, 29, 30, 31, 32, 33, 34 or 35 g, including any fractions thereof) of flour;
(c) 1.8-2.2 mL (i.e. 1.8, 1.9, 2.0, 2.1 or 2.2 g including any fractions thereof) of a 1.25% (w:w) methylcellulose solution in water;
(d) 1.8-2.2 mL (i.e. 1.8, 1.9, 2.0, 2.1 or 2.2 g including any fractions thereof) of glycerol;
(e) 55-65 g (or mL) (i.e. 55, 56, 57, 58, 59, 60, 61, 62, 63, 64 or 65 g, including any fractions thereof) of water.

Thus, according to one embodiment, the weight (w:w) ratio between the mixture of the organic waste component, the adhesive component and water is in the range from about 2:1:2 to about 1.5:1:1.5.

Mixtures according to embodiments of the invention can form dough like material, which, upon drying may become rigid.

In another aspect the present invention provides a bio-degradable container. In another aspect the present invention provides that the phrase “bio-degradable container” is synonymous with the terms “bio-degradable article” or “bio-degradable device”. Articles made of the mixtures according to embodiments of the invention may be made as rigid as required, depending on parameters such as the specific ratios of dry (e.g., organic waste and adhesive components) and wet materials (e.g., water) used in the mixture, the particle size of the dry material (larger particles imparting better solidity), the temperature during pressing and other parameters.

In a further aspect of the invention, the bio-degradable article or device is coated or treated with a bio-degradable coating comprising polylactic acid (PLA), ethyl acetate and dichloromethane. A full description of a coating that may be used, according to embodiments of the invention is provided in co-pending PCT application PCT/IL2011/000739 which is hereby incorporated by reference in its entirety.

Water may be added to a mixture containing organic waste and an adhesive to obtain a dough-like composition that may be shaped into boards or any form and or shape. The articles are then dried (possibly while heating). According to another embodiment the mixture is shaped into a flat board by press forming or by thermoforming.

In another embodiment, the term “mixture” according to the invention includes the terms “suspension” or “dispersion”. In another embodiment, a mixture as described herein is homogeneous. In another embodiment, a mixture as described herein is obtained by vigorous mixing in an aqueous solution such as water.

In another embodiment, “water” is deionized water. In another embodiment, “water” is lukewarm water. In another embodiment, the term “comprise” includes the term “consist” or is replaceable by the term “consist”. In another embodiment, the term “about” includes ±10% of the indicated value. In another embodiment, the term “about” includes ±7.5% of the indicated value. In another embodiment, the term “about” includes ±5% of the indicated value.

The following Examples are representative of techniques employed by the inventors in carrying out aspects of the present invention. It should be appreciated that while these techniques are exemplary of embodiments for the practice of the invention, those of skill in the art, in light of the present disclosure, will recognize that numerous modifications can be made without departing from the intended scope of the invention.

### EXAMPLES

### Example 1: Mixture I and Method of Preparation

Biodegradable Mixture I:
60 g mixture of soil and sawdust
30 g wheat flour
2 ml methylcellulose (from a 125 g/10 L concentrated solution)
   2 ml glycerol
   60 ml water

All components are mixed together with water at boiling temperature (approximately 100° C.).

### Example 2: Mixture II and Method of Preparation

Biodegradable Mixture II:
55 g mixture of soil and sawdust
28 g wheat flour
2 g methylcellulose (from a 125 g/10 L concentrated solution)
2 ml glycerol
60 ml water

All components are mixed together with water at boiling temperature (approximately 100° C.).

### Example 3: Mixture III and Method of Preparation

Biodegradable Mixture III:
65 g mixture of soil and sawdust
32 g wheat flour
2 g methylcellulose (from a 125 g/10 L concentrated solution)
2 ml glycerol
60 ml water

All components are mixed together with water at boiling temperature (approximately 100° C.).

### Example 4: Mixture IV and Method of Preparation

Biodegradable Mixture IV:
60 g mixture of coffee residue
30 g wheat flour
2 ml methylcellulose (from a 125 g/8.5 L concentrated solution)
2 ml glycerol
60 ml water

All components are mixed together with water.

### Example 5: Mixture V and Method of Preparation

Biodegradable Mixture V:
95 gr saw dust
50 gr soil
95 gr compost
100 gr wheat flour
6 g mucilage (optional)
6 g articleassium sorbate (optional)
6 cc Propylene glycol
10 cc methylcellulose (from a 125 g/10 L (water) concentrated solution)
10 cc glycerol
230 cc water
Ash 40-50 gr (cellulosic/lignocellulosic)

The process of making the mixture included the following pre-preparation of sawdust and/or wood chips in organic acid solution; 25% of the starch (flour) was added; steam was applied to approximately 15% humidity and kept in such conditions until it was added to the rest of the material.

The materials were added under constant mixing (lukewarm water, methyl cellulose, propylene glycol, and glycerol. These materials were adequately mixed until a homogenous mixture was obtained.

Then, the following were added: organic acid mixture, articleassium sorbate, mucilage (in this recipe fenugreek was chosen; but mucilage material can include but is not limited to: Aloe vera; Basella alba (Malabar spinach); cactus; Chondrus crispus (Irish moss); Dioscorea opposita (nagaimo, Chinese yam); Drosera (sundews); Drosophyllum lusitanicum; fenugreek, flax seeds; kelp, liquorice root; marshmallow; mallow; mullein, okra; parthenium; pinguicula (butterwort); Psyllium seed husks; salvia hispanica (chia) seed; Ulmus rubra bark (slippery elm)).

The above materials were adequately mixed for <1 min, until mixture became homogenous. Then the following were added: cellulosic/lignocellulosic material (here, wood; can be nutshells, etc.); may include wood ash: the equivalent of 2.5-4 g per article made of the mixture, starch (wheat starch; can include, but not limited to: articleato, rice, corn starches), compost and/or humus; may include addition of “compost tea”: 1-3 mL per article, soil/dirt mixture, optional addition at this stage may include any of a series of known slow-release fertilizer compounds (e.g. Osmocoat, articleassium humate granular, etc.)).

These materials were adequately mixed until mixture became adequately homogenous; dough stored in a proofer to maintain moisture levels and to increase material temperature to 30-50° C.

The spheres were created by press. The press process comprised of two or three separate parts: the base, or ‘male’ counterpart; the sheath, or ‘female’ counterpart; and the plunger. Alternately, the sheath and plunger were combined into one piece (the sheath-plunger).

The parts of the press are pre-heated (base: 135° C., sheath: 150-170° C., plunger: 145-160° C., or sheath-plunger: 150-170° C.). Each of the parts was oiled with an emulsion of water and palm oil in a 40:60 ratio.

The obtained dough like mixture was separated via automated procedure into small flattened-spherical masses, whose weight will depend on the product being formed (e.g. for 12 cm spheres-130-150 g each. These masses were situated onto the base of mold; and the plunger, or the sheath-plunger was raised slowly down all the way onto the base (30-180 s).

The temperature of mold pieces was increased to: base, 170-220° C.; sheath, 170-220° C.; plunger, 160-200° C., or sheath-plunger, 160-200° C.; the material was baked in this way for 4-6 minutes; alternatively the material was injected and was molded into its final shape. The mold was either opened at once, or pre-cooled and then opened; the sphere was then removed from the base, and allowed to further cool to room temperature.

### Coating Process

Pre-coating spray or dip was applied using water and/or water oil in 50:50 emulsion containing antibacterial/antifungal material, including but not limited to: methyl paraben, Trelin TC®, additional organic acids. The coating process was conducted either by immersion in solution, thermofilm-coated, or spray coated. Immersion entails 5 seconds to 10 minutes in solvent (includes, but not limited to ethyl acetate, methylene chloride, butyl acetate, acetone, butanol) containing dissolved PLA (Natureworks, series 2000 or 4000 and/or Toyobo, Vyloecol BE400). Disclosed and described, it is to be understood that this invention is not limited to the particular examples, process steps, and materials disclosed herein as such process steps and materials may vary somewhat. It is also to be understood that the terminology used herein is used for the purpose of describing particular embodiments only and not intended to be limiting since the scope of the present invention will be limited only by the appended claims and equivalents thereof.

Physical Characteristics of a Sphere Made from the Mixture of the Invention

Average weight of uncoated article: 75.0±3.0 g

Average material density of uncoated article: 0.79 (±0.3) g/mL

Thickness of material: upper rim 0.2-0.8±0.05 cm;

Vertical strength of uncoated article=70 kg pressure applied on the sphere's rim (described below)˜5 kg/cm²

Vertical strength of coated article=80 kg pressure applied on the article's)˜6 kg/cm²

Lateral strength of uncoated article=˜3-4 kg

Lateral strength of coated article=˜6 kg

Punch test strength of uncoated article: top of article/near bottom of article/average=6.4/10.6/8.5 kg/cm²

Punch test strength of coated article: top of article/near bottom of article/average=8.5/13.8/11.2 kg/cm²

Thicknesses were measured using a vernier caliper. Vertical strength was measured as the weight required to crush articles 30 mm (top to bottom, with sphere standing upright) by lowering a vertically sliding platform outfitted with gradually increasing weights. Lateral strength was measured using a similar set up, with the requirement to crush the articles 50 mm (container lying on its side with a weight placed on the top edge of the container). Punch test strength was measured using a hand-held penetrometer unit (QA Supplies, FT-444, Capacity: 20 kg×200 g), outfitted with a 1.1 cm plunger tip, and applied to the walls of the sphere at about 2 cm from the top of the article, and about 2 cm from the bottom of the article.

### Example 6: Insect Trap Based on the Dried Mixture of Example 1-5

A board was prepared according to examples 1-5. A yellow sticky paper was adhered to the board. A chemical insect attractant is contacted with the sticky paper or in proximity to the sticky paper. The insect trap was fixed via a nail or a string to a stand.

Optionally, sticky papers are adhered to multiple s articles or surfaces on one side or both sides of the board.

Another trap having a number of sticky papers, wherein each sticky paper is contacted with a specific chemical attractant, wherein each specific chemical attractant attracts a specific insect species, is prepared.

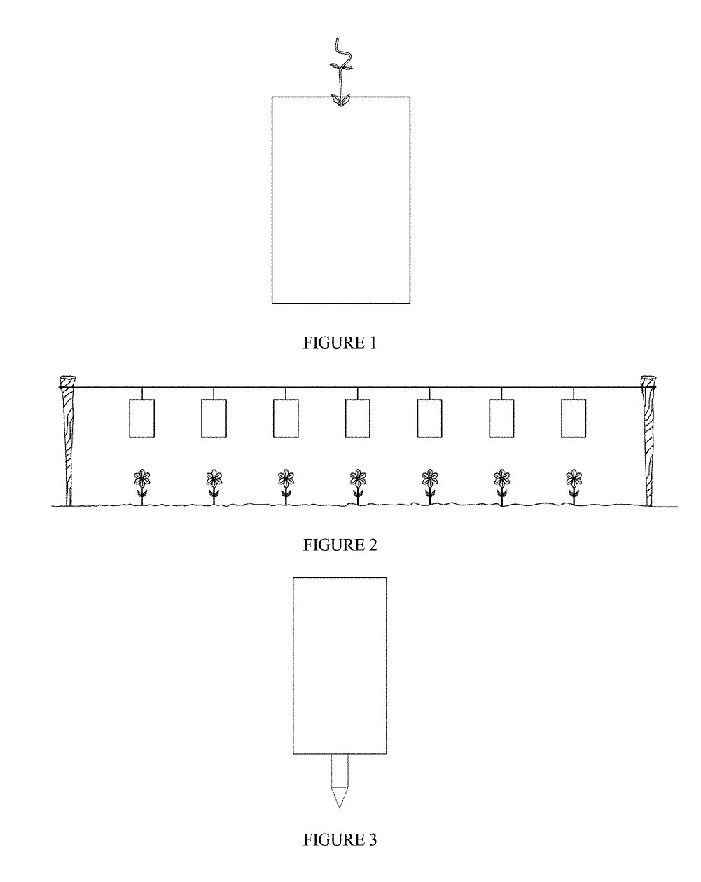

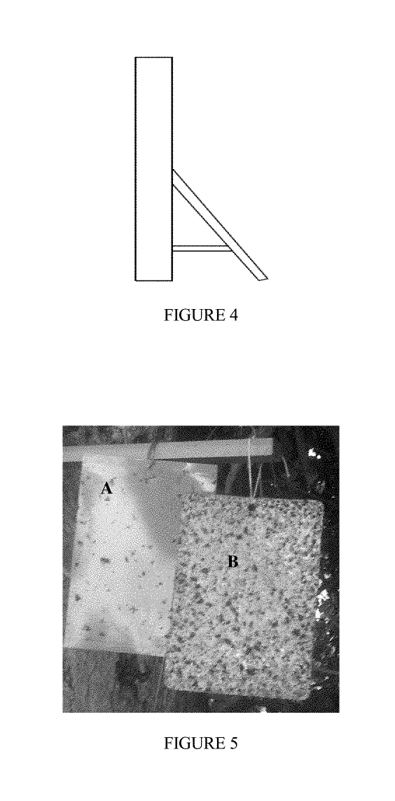

Alternatively, a board was prepared according to any one of examples 1-5. A sticky paper was adhered to the board or sphere (see FIGS. 1-4). A light source such as a fluorescent light source is fixed and reflects light towards the sticky paper. The insect trap is fixed via a nail or a string to a stand.

### Example 7: Insect Trap Based on the Dried Mixture of Example 1-5 is Significantly More Effective than a Parallel, Commercial, Trap Based on a Plastic Board

An experimental trap (FIG. 5B) composed of the dried solid support of example 2 in the form of a board and a yellow sticky paper (Olson Yellow Sticky Traps—3″×5″) adhered onto the solid support was placed on a pecan tree at a height of 1.75 meters. A control trap (FIG. 5A) composed of a plastic support board and the same yellow sticky paper (Olson Yellow Sticky Traps—3″×5″) adhered onto a plastic support board was placed on a pecan tree at a height of 1.75 meters, parallel to the experimental trap. The area where the traps were placed is densely occupied with orange trees and pecan trees. Two weeks after the placement of the traps 568 insects were adhered to the experimental trap wherein the control, commercial, trap contained only 195 insects. Within the experimental trap: 293 insects were identified as house fly, 205 insects were identified as fruit fly, and 47 insects were identified as anisoptera. Within the control trap: 81 insects were identified as house fly, 69 insects were identified as fruit fly, and 11 insects were identified as anisoptera.

1. A device comprising: (a) a solid mixture comprising: at least one organic waste component, at least one organic adhesive component and at least one organic plasticizer or emulsifying agent, wherein said organic waste component comprises particles that are equal to or smaller than 2 mm; and (b) an insect catching surface attached to said solid mixture.

2. The device of claim 1, wherein said device is biodegradable.

3. The device of claim 1, wherein said mixture is further coated with a coating layer and said insects catching surface is attached to said coating.

4. The device of claim 3, wherein said coating layer comprises polylactic acid (PLA).

5. The device of claim 1, further comprising an insect attractant.

6. The device of claim 1, wherein said mixture further comprises mucilage, a sorbic acid salt, propylene, or any combination thereof.

7. The device of claim 1, wherein said organic adhesive component is any one of flour, methylcellulose, or a combination thereof.

8. The device of claim 1, wherein said organic plasticizer or emulsifying agent is any one of glycerol, glycerin, PEG, or any combination thereof.

9. The device of claim 1, wherein said organic waste component is a mixture of at least two components selected from the group consisting: soil, wood chips, saw dust, compost, and ash.

10. The device of claim 9, wherein said wood chips, saw dust, or their combination is pre-treated with an organic acid.

11. The device of claim 1, wherein said mixture further comprises water.

12. The device of claim 11, wherein the weight ratio: of said water compared to said organic waste in said mixture is at least 1.5.

13. The device of claim 1, wherein said mixture is in the form of a flat surface.

14. A device comprising: (a) a solid mixture comprising: methylcellulose, plant chips soaked in an organic acid, flour, water, glycerol, mucilage, sorbate acid salt, ash and compost, wherein said plant chips comprises particles that are equal to or smaller than 2 mm; and (b) an adhesive insect catching surface attached to said solid mixture.

15. The device of claim 14, wherein said plant chips are wood chips.

16. The device of claim 14, wherein said ash is wood ash.

17. A process for making an insect trap, comprising making a solid mixture and attaching an insect catching surface to said solid mixture, wherein said solid mixture comprises methylcellulose and flour; and at least one organic plasticizer or emulsifying agent, wherein said organic waste component comprises particles that are equal to or smaller than 2 mm, wherein said making the solid mixture comprises the steps of:
a. obtaining a methylcellulose solution;
b. mixing said methylcellulose solution, said organic plasticizer, flour, said organic waste component and water; and
c. drying the mixture obtained in step b, thereby making an insect trap.

18. The process of claim 17, wherein said making the solid mixture further comprises coating the dried mixture obtained in step c.

19. The process of claim 17, wherein the weight ratio of said water compared to said organic waste is at least 1.5.
